(19) United States
(12) Patent Application Publication
(10) Pub. No.: US 2025/0377929 A1
(43) Pub. Date: Dec. 11, 2025

(54) IDENTIFICATION OF PATTERNS IN TASK EXECUTION DATA FOR TASK MINING

(71) Applicant: UiPath, Inc., New York, NY (US)

(72) Inventors: Justin MARKS, Redmond, WA (US); Noopur INANI, Marion, IA (US); Chen CHEN, Bellevue, WA (US)

(73) Assignee: UiPath, Inc., New York, NY (US)

(21) Appl. No.: 18/737,919

(22) Filed: Jun. 7, 2024

(51) Int. Cl. G06F 9/48

(52) U.S. Cl. CPC G06F 9/485

(57) ABSTRACT

Systems and methods for identifying patterns of sequences of actions for performing a task from task execution data are provided. The task execution data of user interaction with a computing system for performing the task is received. A task graph is generated based on the task execution data. Patterns of sequences of actions for performing the task are identified based on the task graph. The identified patterns are output.

### FIELD

The present invention generally relates to task mining, and more specifically, to the identification of patterns in user data for task mining.

### BACKGROUND

Task mining is the process of automatically capturing and analyzing user interactions with a computing system to understand how tasks are performed in real-world scenarios. Task mining data can be used to improve productivity, streamline processes, and identify areas for optimization. One challenge associated with task mining is that different users perform different actions to perform a task. For example, when users receive an invoice via email, some users may enter the invoice into ERP (enterprise resource planning) software to open the invoice while other users may open the email in the email client, open the invoice in the email, and copy and paste data in the invoice into bookkeeping software. Conventional approaches to task mining have difficulty identifying repetitive patterns for performing a task where different users perform different actions to perform the task. Accordingly, an improved and/or alternative approach may be beneficial.

### SUMMARY

Certain embodiments of the present invention may provide alternatives or solutions to the problems and needs in the art that have not yet been fully identified, appreciated, or solved by current task mining technologies. For example, some embodiments of the present invention pertain to the identification of patterns in task execution data for task mining.

In accordance with one or more embodiments, systems and methods for identifying patterns of sequences of actions for performing a task from task execution data are provided. The task execution data of user interaction with a computing system for performing the task is received. A task graph is generated based on the task execution data. Patterns of sequences of actions for performing the task are identified based on the task graph. The identified patterns are output.

In one embodiment, the patterns of the sequences of the actions for performing the task are identified using a language model. The language model may be a large language model.

In one embodiment, user input defining a start action, an end action, and an additional action is received. The sequences of the actions are identified in the task graph that are between the start action and the end action and include the additional action. The task graph may be filtered to identify the sequences of the actions that start with the start action and end with the end action. A similarity measure between a first sequence of the sequences of the actions and a second sequence of the sequences of the actions may be determined.

In one embodiment, user input modifying the task graph may be received.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is an architectural diagram illustrating a computing system configured to implement one or more embodiments of the present invention.

FIG. 2A illustrates an example of a neural network that has been trained to recognize graphical elements in an image, according to an embodiment of the present invention.

FIG. 2B illustrates an example of a neuron, according to an embodiment of the present invention.

FIG. 3 is a flowchart illustrating a process for training AI/ML model(s), according to an embodiment of the present invention.

FIG. 4 is a method for identifying patterns of actions for performing a task in task execution data, in accordance with one or more embodiments.

Unless otherwise indicated, similar reference characters denote corresponding features consistently throughout the attached drawings.

### DETAILED DESCRIPTION OF THE EMBODIMENTS

Some embodiments pertain to identification of patterns in task execution data for task mining.

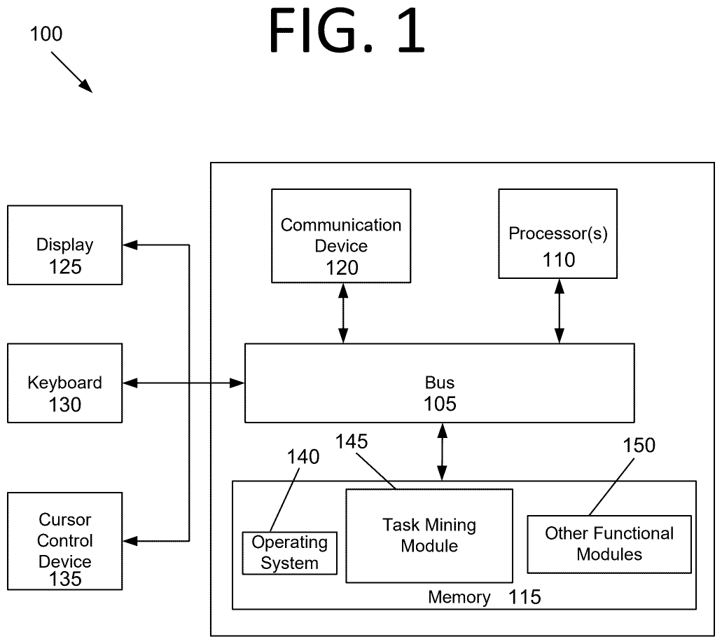

FIG. 1 is an architectural diagram illustrating a computing system 100 configured to implement embodiment of the present invention. In some embodiments, computing system 100 may be one or more of the computing systems depicted and/or described herein. Computing system 100 includes a bus 105 or other communication mechanism for communicating information, and processor(s) 110 coupled to bus 105 for processing information. Processor(s) 110 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 110 may also have multiple processing cores, and at least some of the cores may be configured to perform specific functions. Multi-parallel processing may be used in some embodiments. In certain embodiments, at least one of processor(s) 110 may be a neuromorphic circuit that includes processing elements that mimic biological neurons. In some embodiments, neuromorphic circuits may not require the typical components of a Von Neumann computing architecture.

Computing system 100 further includes a memory 115 for storing information and instructions to be executed by processor(s) 110. Memory 115 can be comprised of any combination of random access memory (RAM), read-only memory (ROM), flash memory, cache, static storage such as a magnetic or optical disk, or any other types of non-transitory computer-readable media or combinations thereof. Non-transitory computer-readable media may be any available media that can be accessed by processor(s) 110 and may include volatile media, non-volatile media, or both. The media may also be removable, non-removable, or both. Computing system 100 includes a communication device 120, such as a transceiver, to provide access to a communications network via a wireless and/or wired connection. In some embodiments, communication device 120 may include one or more antennas that are singular, arrayed, phased, switched, beamforming, beamsteering, a combination thereof, and or any other antenna configuration without deviating from the scope of the invention.

Processor(s) 110 are further coupled via bus 105 to a display 125. Any suitable display device and haptic I/O may be used without deviating from the scope of the invention.

A keyboard 130 and a cursor control device 135, such as a computer mouse, a touchpad, etc., are further coupled to bus 105 to enable a user to interface with computing system 100. However, in certain embodiments, a physical keyboard and mouse may not be present, and the user may interact with the device solely through display 125 and/or a touchpad (not shown). Any type and combination of input devices may be used as a matter of design choice. In certain embodiments, no physical input device and/or display is present. For instance, the user may interact with computing system 100 remotely via another computing system in communication therewith, or computing system 100 may operate autonomously.

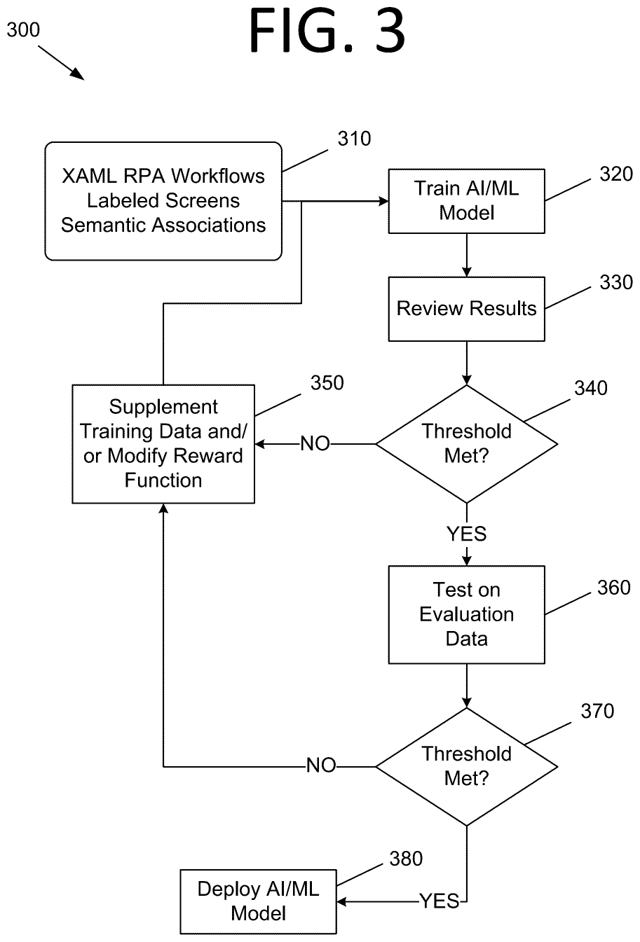

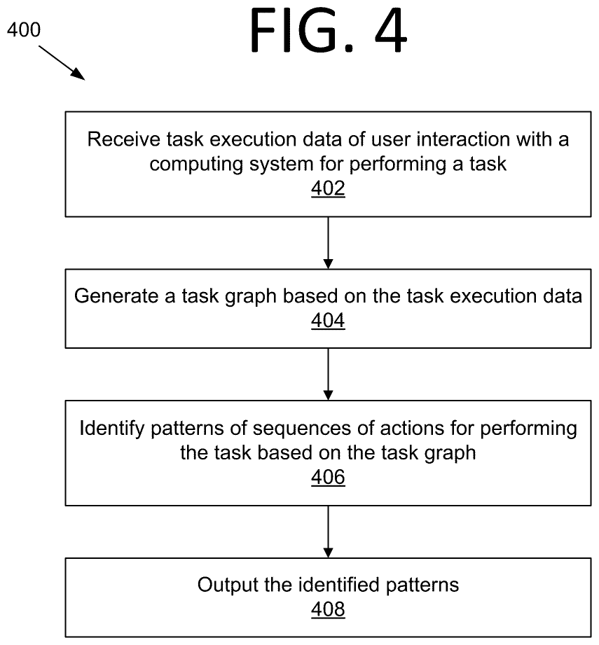

Memory 115 stores software modules that provide functionality when executed by processor(s) 110. The modules include an operating system 140 for computing system 100. The modules further include a task mining module 145 that is configured to perform all or part of the processes/methods described herein (e.g., process 300 of FIG. 3 and/or method 400 of FIG. 4) or derivatives thereof. Computing system 100 may include one or more additional functional modules 150 that include additional functionality.

One skilled in the art will appreciate that a “computing system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems. The computing system could be part of or otherwise accessible by a local area network (LAN), a mobile communications network, a satellite communications network, the Internet, a public or private cloud, a hybrid cloud, a server farm, any combination thereof, etc. Any localized or distributed architecture may be used without deviating from the scope of the invention.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

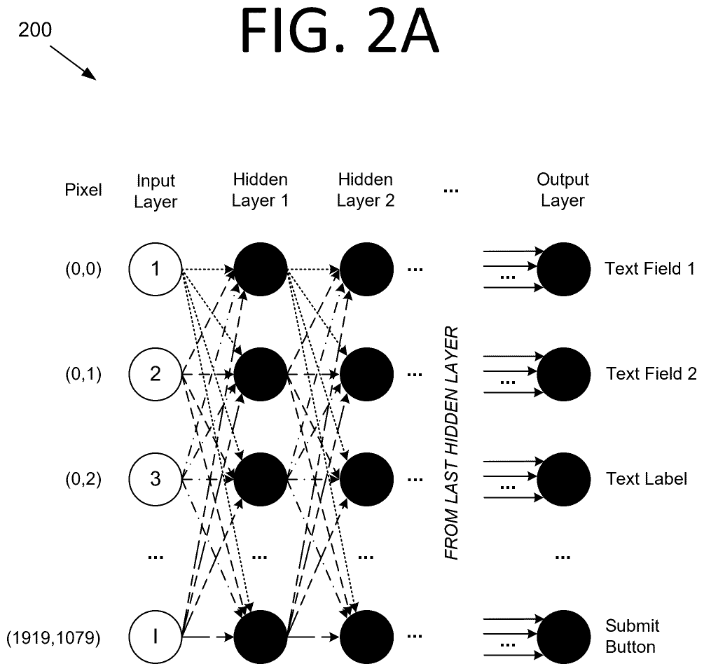

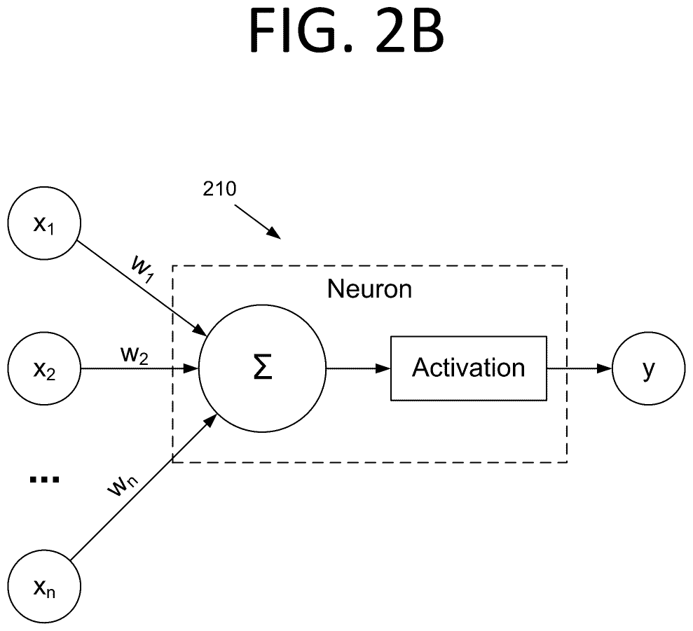

Various types of AI/ML models may be trained and deployed for implementing embodiments of the invention without deviating from the scope of the invention. For instance, FIG. 2A illustrates an example of a neural network 200 that has been trained to recognize graphical elements in an image, according to an embodiment of the present invention. Here, neural network 200 receives pixels of a screenshot image of a 1920×1080 screen as input for input “neurons” 1 to I of the input layer. In this case, I is 2,073,600, which is the total number of pixels in the screenshot image.

Neural network 200 also includes a number of hidden layers. Both DLNNs and shallow learning neural networks (SLNNs) usually have multiple layers, although SLNNs may only have one or two layers in some cases, and normally fewer than DLNNs. Typically, the neural network architecture includes an input layer, multiple intermediate layers, and an output layer, as is the case in neural network 200.

A DLNN often has many layers (e.g., 10, 50, 200, etc.) and subsequent layers typically reuse features from previous layers to compute more complex, general functions. A SLNN, on the other hand, tends to have only a few layers and train relatively quickly since expert features are created from raw data samples in advance. However, feature extraction is laborious. DLNNs, on the other hand, usually do not require expert features, but tend to take longer to train and have more layers.

For both approaches, the layers are trained simultaneously on the training set, normally checking for overfitting on an isolated cross-validation set. Both techniques can yield excellent results, and there is considerable enthusiasm for both approaches. The optimal size, shape, and quantity of individual layers varies depending on the problem that is addressed by the respective neural network.

Returning to FIG. 2A, pixels provided as the input layer are fed as inputs to the J neurons of hidden layer 1. While all pixels are fed to each neuron in this example, various architectures are possible that may be used individually or in combination including, but not limited to, feed forward networks, radial basis networks, deep feed forward networks, deep convolutional inverse graphics networks, convolutional neural networks, recurrent neural networks, artificial neural networks, long/short term memory networks, gated recurrent unit networks, generative adversarial networks, liquid state machines, auto encoders, variational auto encoders, denoising auto encoders, sparse auto encoders, extreme learning machines, echo state networks, Markov chains, Hopfield networks, Boltzmann machines, restricted Boltzmann machines, deep residual networks, Kohonen networks, deep belief networks, deep convolutional networks, support vector machines, neural Turing machines, or any other suitable type or combination of neural networks without deviating from the scope of the invention.

Hidden layer 2 receives inputs from hidden layer 1, hidden layer 3 receives inputs from hidden layer 2, and so on for all hidden layers until the last hidden layer provides its outputs as inputs for the output layer. It should be noted that numbers of neurons I, J, K, and L are not necessarily equal, and thus, any desired number of layers may be used for a given layer of neural network 200 without deviating from the scope of the invention. Indeed, in certain embodiments, the types of neurons in a given layer may not all be the same.

Neural network 200 is trained to assign a confidence score to graphical elements believed to have been found in the image. In order to reduce matches with unacceptably low likelihoods, only those results with a confidence score that meets or exceeds a confidence threshold may be provided in some embodiments. For instance, if the confidence threshold is 80%, outputs with confidence scores exceeding this amount may be used and the rest may be ignored. In this case, the output layer indicates that two text fields, a text label, and a submit button were found. Neural network 200 may provide the locations, dimensions, images, and/or confidence scores for these elements without deviating from the scope of the invention, which can be used subsequently by an RPA robot or another process that uses this output for a given purpose.

It should be noted that neural networks are probabilistic constructs that typically have a confidence score. This may be a score learned by the AI/ML model based on how often a similar input was correctly identified during training. For instance, text fields often have a rectangular shape and a white background. The neural network may learn to identify graphical elements with these characteristics with a high confidence. Some common types of confidence scores include a decimal number between 0 and 1 (which can be interpreted as a percentage of confidence), a number between negative ∞ and positive ∞, or a set of expressions (e.g., “low,” “medium,” and “high”). Various post-processing calibration techniques may also be employed in an attempt to obtain a more accurate confidence score, such as temperature scaling, batch normalization, weight decay, negative log likelihood (NLL), etc.

“Neurons” in a neural network are mathematical functions that that are typically based on the functioning of a biological neuron. Neurons receive weighted input and have a summation and an activation function that governs whether they pass output to the next layer. This activation function may be a nonlinear thresholded activity function where nothing happens if the value is below a threshold, but then the function linearly responds above the threshold (i.e., a rectified linear unit (ReLU) nonlinearity). Summation functions and ReLU functions are used in deep learning since real neurons can have approximately similar activity functions. Via linear transforms, information can be subtracted, added, etc. In essence, neurons act as gating functions that pass output to the next layer as governed by their underlying mathematical function. In some embodiments, different functions may be used for at least some neurons.

An example of a neuron 210 is shown in FIG. 2B. Inputs x₁, x₂, . . . , xₙ from a preceding layer are assigned respective weights w₁, w₂, . . . , wₙ. Thus, the collective input from preceding neuron 1 is w₁x₁. These weighted inputs are used for the neuron's summation function modified by a bias, such as:

$${\sum }_{i = 1}^{m} ( {w}_{i} {x}_{i} ) + bias \qquad ( 1 )$$

This summation is compared against an activation function ƒ(x) to determine whether the neuron “fires”. For instance, ƒ(x) may be given by:

$$f ( x ) = \{ \begin{matrix}1 if \sum wx + bias \geq 0 \\ 0 if \sum wx + bias < 0\end{matrix} \qquad ( 2 )$$

The output y of neuron 210 may thus be given by:

$$y = f ( x ) {\sum }_{i = 1}^{m} ( {w}_{i} {x}_{i} ) + bias \qquad ( 3 )$$

In this case, neuron 210 is a single-layer perceptron. However, any suitable neuron type or combination of neuron types may be used without deviating from the scope of the invention. It should also be noted that the ranges of values of the weights and/or the output value(s) of the activation function may differ in some embodiments without deviating from the scope of the invention.

The goal, or “reward function” is often employed, such as for this case the successful identification of graphical elements in the image. A reward function explores intermediate transitions and steps with both short-term and long-term rewards to guide the search of a state space and attempt to achieve a goal (e.g., successful identification of graphical elements, successful identification of a next sequence of activities for an RPA workflow, etc.).

During training, various labeled data (in this case, images) are fed through neural network 200. Successful identifications strengthen weights for inputs to neurons, whereas unsuccessful identifications weaken them. A cost function, such as mean square error (MSE) or gradient descent may be used to punish predictions that are slightly wrong much less than predictions that are very wrong. If the performance of the AI/ML model is not improving after a certain number of training iterations, a data scientist may modify the reward function, provide indications of where non-identified graphical elements are, provide corrections of misidentified graphical elements, etc.

Backpropagation is a technique for optimizing synaptic weights in a feedforward neural network. Backpropagation may be used to “pop the hood” on the hidden layers of the neural network to see how much of the loss every node is responsible for, and subsequently updating the weights in such a way that minimizes the loss by giving the nodes with higher error rates lower weights, and vice versa. In other words, backpropagation allows data scientists to repeatedly adjust the weights so as to minimize the difference between actual output and desired output.

The backpropagation algorithm is mathematically founded in optimization theory. In supervised learning, training data with a known output is passed through the neural network and error is computed with a cost function from known target output, which gives the error for backpropagation. Error is computed at the output, and this error is transformed into corrections for network weights that will minimize the error.

In the case of supervised learning, an example of backpropagation is provided below. A column vector input x is processed through a series of N nonlinear activity functions ƒᵢ between each layer i=1, . . . , N of the network, with the output at a given layer first multiplied by a synaptic matrix Wᵢ, and with a bias vector bᵢ added. The network output o, given by

$$o = {f}_{N} ( {W}_{N} {f}_{N - 1} ( {W}_{N - 1} {f}_{N - 2} ( … {f}_{1} ( {W}_{1} x + {b}_{1} ) … ) + {b}_{N - 1} ) + {b}_{N} ) \qquad ( 4 )$$

In some embodiments, o is compared with a target output t, resulting in an error

$$E = \frac{1}{2} {‖ o - t ‖}^{2} ,$$

which is desired to be minimized.

Optimization in the form of a gradient descent procedure may be used to minimize the error by modifying the synaptic weights Wᵢ for each layer. The gradient descent procedure requires the computation of the output o given an input x corresponding to a known target output t, and producing an error o−t. This global error is then propagated backwards giving local errors for weight updates with computations similar to, but not exactly the same as, those used for forward propagation. In particular, the backpropagation step typically requires an activity function of the form

$${p}_{j} ( {n}_{j} ) = {f}_{j}^{′} ( {n}_{j} ) ,$$

where nⱼ is the network activity at layer j (i.e., nⱼ=Wⱼoⱼ₋₁+bⱼ) where oⱼ=ƒⱼ(nⱼ) and the apostrophe ' denotes the derivative of the activity function ƒ.

The weight updates may be computed via the formulae:

$${d}_{j} = \{ \begin{matrix}( o - t ) ∘ {p}_{j} ( {n}_{j} ) , & j = N \\ {W}_{j + 1}^{T} {d}_{j + 1} ∘ {p}_{j} ( {n}_{j} ) , & j < N\end{matrix} \qquad ( 5 )$$

$$\frac{\partial E}{\partial {W}_{j + 1}} = {{d}_{j + 1} ( {o}_{j} )}^{T} \qquad ( 6 )$$

$$\frac{\partial E}{\partial {b}_{j + 1}} = {d}_{j + 1} \qquad ( 7 )$$

$${W}_{j}^{new} = {W}_{j}^{old} - η \frac{\partial E}{\partial {W}_{j}} \qquad ( 8 )$$

$${b}_{j}^{new} = {b}_{j}^{old} - η \frac{\partial E}{\partial {b}_{j}} \qquad ( 9 )$$

where ∞ denotes a Hadamard product (i.e., the element-wise product of two vectors), ^{T} denotes the matrix transpose, and oⱼ denotes ƒⱼ(Wⱼoⱼ₋₁+bⱼ), with o₀=x. Here, the learning rate η is chosen with respect to machine learning considerations. Below, η is related to the neural Hebbian learning mechanism used in the neural implementation. Note that the synapses W and b can be combined into one large synaptic matrix, where it is assumed that the input vector has appended ones, and extra columns representing the b synapses are subsumed to W.

The AI/ML model may be trained over multiple epochs until it reaches a good level of accuracy (e.g., 97% or better using an F2 or F4 threshold for detection and approximately 2,000 epochs). This accuracy level may be determined in some embodiments using an F1 score, an F2 score, an F4 score, or any other suitable technique without deviating from the scope of the invention. Once trained on the training data, the AI/ML model may be tested on a set of evaluation data that the AI/ML model has not encountered before. This helps to ensure that the AI/ML model is not “over fit” such that it identifies graphical elements in the training data well, but does not generalize well to other images.

In some embodiments, it may not be known what accuracy level is possible for the AI/ML model to achieve. Accordingly, if the accuracy of the AI/ML model is starting to drop when analyzing the evaluation data (i.e., the model is performing well on the training data, but is starting to perform less well on the evaluation data), the AI/ML model may go through more epochs of training on the training data (and/or new training data). In some embodiments, the AI/ML model is only deployed if the accuracy reaches a certain level or if the accuracy of the trained AI/ML model is superior to an existing deployed AI/ML model.

In certain embodiments, a collection of trained AI/ML models may be used to accomplish a task, such as employing an AI/ML model for each type of graphical element of interest, employing an AI/ML model to perform OCR, deploying yet another AI/ML model to recognize proximity relationships between graphical elements, employing still another AI/ML model to generate an RPA workflow based on the outputs from the other AI/ML models, etc. This may collectively allow the AI/ML models to enable semantic automation, for instance.

Some embodiments may use transformer networks such as SentenceTransformers™, which is a Python™ framework for state-of-the-art sentence, text, and image embeddings. Such transformer networks learn associations of words and phrases that have both high scores and low scores. This trains the AI/ML model to determine what is close to the input and what is not, respectively. Rather than just using pairs of words/phrases, transformer networks may use the field length and field type, as well.

FIG. 3 is a flowchart illustrating a process 300 for training AI/ML model(s), according to an embodiment of the present invention. The process begins with providing training data, for instance, labeled data as shown in FIG. 3, such as labeled screens (e.g., with graphical elements and text identified), words and phrases, a “thesaurus” of semantic associations between words and phrases such that similar words and phrases for a given word or phrase can be identified, etc. at 310. The nature of the training data that is provided will depend on the objective that the AI/ML model is intended to achieve. The AI/ML model is then trained over multiple epochs at 320 and results are reviewed at 330.

If the AI/ML model fails to meet a desired confidence threshold at 340, the training data is supplemented and/or the reward function is modified to help the AI/ML model achieve its objectives better at 350 and the process returns to step 320. If the AI/ML model meets the confidence threshold at 340, the AI/ML model is tested on evaluation data at 360 to ensure that the AI/ML model generalizes well and that the AI/ML model is not over fit with respect to the training data. The evaluation data may include screens, source data, etc. that the AI/ML model has not processed before. If the confidence threshold is met at 370 for the evaluation data, the AI/ML model is deployed at 380. If not, the process returns to step 350 and the AI/ML model is trained further.

In task mining, user interactions with computers are analyzed to understand how tasks are performed. Conventional approaches to task mining have difficulty identifying repetitive patterns for performing a task in user interaction data where different users perform different actions to perform the task. Embodiments described herein provide for the identification of patterns in user data for task mining. Task execution data of user interaction with a computing system for performing a task is recorded and a task graph is generated based on the task execution data. Patterns for performing the task are identified based on the task graph. In an automated approach, a large language model is applied to identify the patterns from the task graph. In a human-in-the-loop approach, user input is received defining a start bookmark task and an end bookmark task and sequences of activities representing the patterns are identified from the task graph between the start bookmark task and the end bookmark task. Advantageously, embodiments described herein provide for the identification of patterns in user data for task mining with increased accuracy as compared to conventional approaches.

FIG. 4 shows a method 400 for identifying patterns of actions for performing a task in task execution data, in accordance with one or more embodiments. The steps and/or sub-steps of method 400 may be perform by any suitable computing system or systems, such as, e.g., computing system 100 of FIG. 1.

At step 402 of FIG. 4, task execution data of user interaction with a computing system for performing a task is received. The task execution data comprises any data associated with actions/activities performed by a user interacting with the computing system to perform the task, such as, e.g., event logs of user actions (e.g., clicks, keystrokes, or navigation paths within applications or websites), timestamps, data associated with applications or systems used, user input (e.g., text or selections), screen captures, system metrics, metadata, etc. The task may be any suitable task performed by the user interacting with the computing system (e.g., saving an invoice).

The task execution data may be received, for example, by loading the task execution data from a storage or memory of a computer system (e.g., memory 115 of computing system 100 of FIG. 1) or by receiving the task execution data from a remote computer system (e.g., computing system 100 of FIG. 1).

At step 404 of FIG. 4, a task graph is generated based on the task execution graph. The task graph represents relationships between actions for performing tasks. The task graph may be a directed graph comprising 1) a set of nodes representing the actions performed by users and 2) edges connecting nodes representing dependencies between the actions.

The task graph may be generated using any suitable approach. In one embodiment, the task graph is generated by analyzing the task execution data to identify sequences of actions performed by the users. Such analysis may include reconstructing the order that the actions were performed in the task execution data and identifying dependencies between the actions. A graph structure is then generated based on the sequences of actions and the dependencies.

In one embodiment, user input may be received modifying the task graph. For example, the user input may add or delete nodes or edges of the task graph to provide additional context around the task.

At step 406 of FIG. 4, patterns of sequences of actions for performing the task are identified based on the task graph. The patterns of the actions may be identified according to an automated approach, a human-in-the-loop approach, or any other suitable approach.

In one embodiment, in the automated approach, the patterns of the sequences of actions for performing the task are identified using a language model. A language model is an artificial intelligence/machine learning model trained to predict a sequence of words. In one embodiment, the language model is an LLM. However, the language model may be any other suitable language model for identifying the patterns of sequences of actions for performing the task, such as, e.g., a small language model having relatively fewer parameters as compared to large language models.

An LLM is a deep learning model trained to, e.g., recognize, summarize, translate, predict, and generate content based on a very large training dataset. The large language model may be any suitable pre-trained deep learning based large language model. For example, the large language model may be based on the transformer architecture, which uses a self-attention mechanism to capture long-range dependencies in text. Examples of transformer-based large language models include GPT (generative pre-training transformer), BLOOM (BigScience Large Open-science Open-access Multilingual Language Model), BERT (Bidirectional Encoder Representations from Transformers), LaMDA (language model for dialogue applications), and Llama (large language model Meta AI). In one embodiment, the large language model is fine-tuned for identifying the patterns of the actions for performing the task.

The language model receives as input the task graph, e.g., via one or more prompts, and generates as output the identified patterns of the actions for performing the task. The one or more prompts may be received, for example, from a user interacting with a computing system (e.g., computing system 100 of FIG. 1) via a chat assistant or from a computer program (e.g., code) executing on a computing system (e.g., computing system 100 of FIG. 1) via one or more APIs (application programming interfaces). The one or more prompts may also comprise instructions defining how the patterns of the activities for performing the task are identified by the language model. The instructions refer to guidelines or directions to guide the behavior and output of the language model. The instructions may include, for example, commands, questions, constraints, requirements, contextual information, and/or any other guideline or direction guiding the behavior and output of the language model.

In one embodiment, in the human-in-the-loop approach, user input defining a start action and an end action is received. The start action and the end action represent bookmarks or endpoints for identifying sequences of actions in the task graph. In one embodiment, the user input may also define one or more additional required actions. For example, in the case where a user wants to see how an employee submits an expense report, the start action may be clicking a “create report” button, the end action may be clicking a “submit report” button, and an additional require action may be clicking an “add expense item” button. The task graph is filtered to identify all sequences of actions that start with the start action, end with the end action, and include the one or more additional required actions. The identified sequences of actions represent the patterns of the sequences of actions for performing the task. In one embodiment, one or more similarity measures between two of the sequences of activities are determined. The one or more similarity measures enable evaluation of what sequences are noise, what sequences are related to the task, and what sequences are unique variations versus common variations. For example, if there are 100 sequences of submitting an expense report, and in two sequences a user writes a message, those two sequences are likely noise and not related to the task so they can be filtered out. Alternatively, if 70% of the sequences open a photo (of a receipt), those sequences are likely part of the task but only occurs in 70% of the variations.

At step 408 of FIG. 4, the identified patterns are output. For example, the identified patterns can be output by displaying the identified patterns on a display device of a computer system (e.g., display 125 of computing system 100 of FIG. 1), storing the identified patterns on a memory or storage of a computer system (e.g., memory 115 of computing system 100 of FIG. 1), or by transmitting the identified patterns to a remote computer system (e.g., computing system 100 of FIG. 1).

In one embodiment, the identified patterns may be used for curating sequences of actions. For example, the identified patterns may be filtered to identify which sequences are valuable and should be considered as true variations of the task and which sequences are noise.

In one embodiment, the identified patterns may be used for automation. An automation skeleton may be generated based on the identified patterns to facilitate design of an automation. For example, the identified patterns may be input into a designer for automatic creation of automations for performing the task.

In one embodiment, the identified patterns may be used to export the task. For example, the task and the identified patterns may be exported to a PDD (process design document) or to an image to be embedded in another document or project.

In one embodiment, the identified patterns may be integrated with process mining to provide valuable insight in the larger context of a process. For example, if a process owner for the P2P (purchase to pay) process wants to understand why purchase order approvals take three days as compared to the one day service level agreement, a task mining project can be run to identify patterns of sequences of actions for performing the task and then export a curated task graph back to process mining. Process mining can then expand the “approve purchase order” activity and provide more detail on how that's done. This also leads to simulation and ROI (return on investment) analysis (e.g., if I automate this flow, how much ROI would I get or how many hours of labor would I save?).

In one embodiment, the identified patterns may be used to provide visibility into how the task is performed. A user can use the visibility for documenting the task.

In one embodiment, the identified patterns may be used for changing the sequences of actions that, for example, are not valid or appropriate (e.g., don't use App X or there's a more efficient or appropriate way to perform the task).

The steps and sub-steps disclosed herein, including the steps and sub-steps of FIGS. 3-4, may be performed by a computer program, encoding instructions for the processor(s) to perform at least part of the process(es) described in FIGS. 3-4, in accordance with embodiments of the present invention. The computer program may be embodied on a non-transitory computer-readable medium. The computer-readable medium may be, but is not limited to, a hard disk drive, a flash device, RAM, a tape, and/or any other such medium or combination of media used to store data. The computer program may include encoded instructions for controlling processor(s) of a computing system (e.g., processor(s) 110 of computing system 100 of FIG. 1) to implement all or part of the steps and sub-steps described in FIGS. 3-4, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer-implemented method comprising:
receiving task execution data of user interaction with a computing system for performing a task;
generating a task graph based on the task execution data;
identifying patterns of sequences of actions for performing the task based on the task graph; and
outputting the identified patterns.

2. The computer-implemented method of claim 1, wherein identifying patterns of sequences of actions for performing the task based on the task graph comprises:
identifying the patterns of the sequences of the actions for performing the task using a language model.

3. The computer-implemented method of claim 2, wherein the language model is a large language model.

4. The computer-implemented method of claim 1, wherein identifying patterns of sequences of actions for performing the task based on the task graph comprises:
receiving user input defining a start action, an end action, and an additional action; and
identifying the sequences of the actions in the task graph that are between the start action and the end action and include the additional action.

5. The computer-implemented method of claim 4, wherein identifying the sequences of the actions in the task graph between the start action and the end action comprises:
filtering the task graph to identify the sequences of the actions that start with the start action and end with the end action.

6. The computer-implemented method of claim 4, further comprising:
determining a similarity measure between a first sequence of the sequences of the actions and a second sequence of the sequences of the actions.

7. The computer-implemented method of claim 1, wherein generating a task graph based on the task execution data comprises:
receiving user input modifying the task graph.

8. A system comprising:
a memory storing computer program instructions; and
at least one processor configured to execute the computer program instructions, the computer program instructions configured to cause the at least one processor to perform operations of:
receiving task execution data of user interaction with a computing system for performing a task;
generating a task graph based on the task execution data;
identifying patterns of sequences of actions for performing the task based on the task graph; and
outputting the identified patterns.

9. The system of claim 8, wherein identifying patterns of sequences of actions for performing the task based on the task graph comprises:
identifying the patterns of the sequences of the actions for performing the task using a language model.

10. The system of claim 9, wherein the language model is a large language model.

11. The system of claim 8, wherein identifying patterns of sequences of actions for performing the task based on the task graph comprises:
receiving user input defining a start action, an end action, and an additional action; and
identifying the sequences of the actions in the task graph that are between the start action and the end action and include the additional action.

12. The system of claim 11, wherein identifying the sequences of the actions in the task graph between the start action and the end action comprises:
filtering the task graph to identify the sequences of the actions that start with the start action and end with the end action.

13. The system of claim 11, further comprising:
determining a similarity measure between a first sequence of the sequences of the actions and a second sequence of the sequences of the actions.

14. The system of claim 8, wherein generating a task graph based on the task execution data comprises:
receiving user input modifying the task graph.

15. A non-transitory computer-readable medium storing computer program instructions, the computer program instructions, when executed on at least one processor, cause the at least one processor to perform operations comprising:
receiving task execution data of user interaction with a computing system for performing a task;
generating a task graph based on the task execution data;
identifying patterns of sequences of actions for performing the task based on the task graph; and
outputting the identified patterns.

16. The non-transitory computer-readable medium of claim 15, wherein identifying patterns of sequences of actions for performing the task based on the task graph comprises:
identifying the patterns of the sequences of the actions for performing the task using a language model.

17. The non-transitory computer-readable medium of claim 16, wherein the language model is a large language model.

18. The non-transitory computer-readable medium of claim 15, wherein identifying patterns of sequences of actions for performing the task based on the task graph comprises:
receiving user input defining a start action, an end action, and an additional action; and
identifying the sequences of the actions in the task graph that are between the start action and the end action and include the additional action.

19. The non-transitory computer-readable medium of claim 18, wherein identifying the sequences of the actions in the task graph between the start action and the end action comprises:
filtering the task graph to identify the sequences of the actions that start with the start action and end with the end action.

20. The non-transitory computer-readable medium of claim 18, further comprising:
determining a similarity measure between a first sequence of the sequences of the actions and a second sequence of the sequences of the actions.
